(19) United States
(12) Patent Application Publication
(10) Pub. No.: US 2025/0206675 A1
(43) Pub. Date: Jun. 26, 2025

(54) INPUT STOCK FOR USE FOR PRODUCING A FIBRE-CERAMIC COMPOSITE

(71) Applicant: ISOVOLTA AG, Wiener Neudorf (AT)

(72) Inventors: Peter WAGNER, Melk (AT); Konstantin HOREJSI, Wien (AT); Christoph HOFER, Vösendorf (AT)

(21) Appl. No.: 18/847,087

(22) PCT Filed: Mar. 10, 2023
(86) PCT No.: PCT/EP2023/056179

§ 371 Date: Sep. 13, 2024

(30) Foreign Application Priority Data
Mar. 16, 2022 (AT) A 50170/2022

(51) Int. Cl. C04B 35/80; C04B 35/628; C04B 35/634; C04B 35/64

(52) U.S. Cl. CPC C04B 35/80; C04B 35/62849; C04B 35/62892; C04B 35/63416; C04B 35/64; C04B 2235/3217; C04B 2235/3418; C04B 2235/5228; C04B 2235/5256; C04B 2235/616; C04B 2235/656

(57) ABSTRACT

An input stock for producing a fiber-ceramic composite comprises 40-55 wt % inorganic fibers consisting of SiO2 and/or Al2O3, 40-50 wt % inorganic oxides, and 5-15 wt % water. The inorganic oxides contain at least 60 wt % SiO2 and at most 25 wt % Al2O3. A method for producing the input stock includes creating a suspension of water, ground inorganic oxides, and polyvinyl alcohol; contacting inorganic fibers with the suspension; and applying pressure to produce a storage-stable input stock. The input stock can be sintered at 900-990° C. to form a fiber-ceramic composite. The resulting composite contains inorganic fibers consisting of SiO2 and Al2O3 in an oxide ceramic matrix consisting of inorganic oxides with at least 60 wt % SiO2 and at most 25 wt % Al2O3.

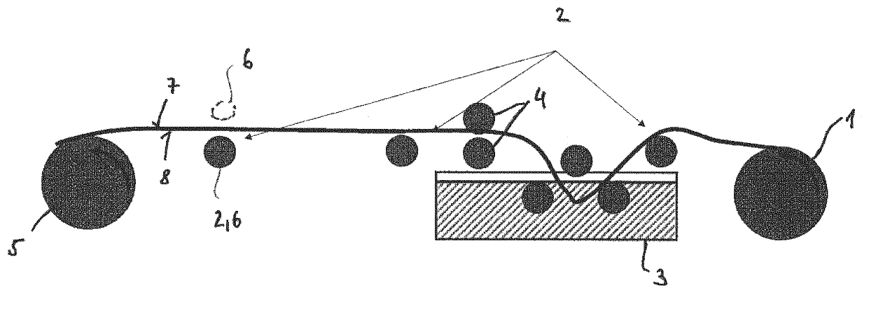

The invention relates to an input stock for use for producing a fiber-ceramic composite, a method for producing such an input stock, the use of such an input stock for producing a fiber-ceramic composite, as well as a fiber-ceramic composite comprising inorganic fibers, in particular oxide and/or mineral fibers, and an oxide ceramic matrix.

It is known to use inorganic fibers for reinforcing ceramic, thus ensuring that the mechanical properties of the fiber-ceramic composite and thus its product properties such as expandability, fracture toughness, and thermoshock resistance are considerably improved.

As inorganic fibers, for example, those predominantly consisting of Al₂O₃, which in the production of the fiber-ceramic composite are embedded in a matrix predominantly consisting of Al₂O₃, are used.

In addition, it is known to provide the fibers and the matrix in the composite consisting of a mixture of Al₂O₃ and SiO₂. In such a mixture, however, a compromise must be found between the properties that are produced by the respective oxide component.

With fiber-reinforced ceramic, a material is available that no longer has important drawbacks of conventional, technical ceramic-namely its low fracture toughness and high temperature sensitivity. Application developments have consequently been concentrated in fields in which reliability at high temperatures that cannot be achieved for metals—in particular over 1000° C.—is required in the case of abrasive, i.e., wear-generating, stresses. The following areas of focus have arisen to date in developments and applications:
Heat protection systems for spacecraft, which upon reentry into the earth's atmosphere are exposed to high thermal stresses and vibration stresses. Components for gas turbines in the field of hot gases (i.e., in the turbine combustion chamber), the static guide vanes directing the gas flow, and the actual turbine vanes that drive the compressors of the gas turbines.
Components for the burner technology and hot-gas guides consisting of oxide composite ceramic.
Brake disks for heavily-loaded disk brakes that are exposed to extreme thermoshock conditions on the friction surfaces.
Components for friction bearings with high corrosion and wear resistance.

It is disadvantageous in the case of known, fiber-reinforced ceramics, however, that the latter give rise to high production costs.

It is therefore the object of the invention to provide an input stock for a fiber-ceramic composite with an oxide matrix and an oxide and/or mineral fiber, which in comparison to a known composite, produced in particular from oxides, has optimized properties and can be produced in a cost-efficient manner.

This object is achieved by an input stock that has the features of claim 1, by a method that has the features of claim 12, by use of an input stock according to claim 15, as well as by a fiber-ceramic composite that has the features of claim 16.

Preferred and advantageous embodiments of the invention are the subject matter of the subclaims.

According to the invention, it is provided that 100 wt. % of input stock contains
40 wt. % to 55 wt. %, in particular 44 wt. % to 50 wt. %, of inorganic fibers consisting of SiO₂ and/or Al₂O₃,
40 wt. % to 50 wt. %, in particular 42 wt. % to 48 wt. %, of inorganic oxides, and
5 wt. % to 15 wt. %, in particular 7.5 wt. % to 9 wt. %, of water,
   and that 100 wt. % of the inorganic oxides contains at least 60 wt. % of SiO₂ and at most 25 wt. % of Al₂O₃.

A more important cost factor during production of a fiber-ceramic composite comes from the energy costs for sintering. In contrast to known fiber-reinforced ceramics, in which the fibers and even the matrix in the composite consist of a mixture predominantly consisting of Al₂O₃ and only a small proportion of SiO₂, the advantage lies in a predominant proportion of SiO₂, provided according to the invention, in particular in the fact that the fibers as well as the matrix can be sintered at relatively low temperatures and thus essentially in a more cost-effective manner, without the mechanical properties and the workability being negatively affected.

Fibers, oxides, and water may not add up to 100 wt. % in the input stock, since the input stock can also have certain percentages by weight of, e.g., polyvinyl alcohol, depending on the production method. Moreover, the input stock in the storable state can have a film that consists of, for example, polyethylene or polypropylene, but its weight can be considered to be negligible. The lighter the film, the better.

The setting of the individual percentages by weight of fibers, oxides, and water, and optionally of polyvinyl alcohol can be selected depending on requirements. With the field of application for, e.g., the tip of a space rocket, a higher proportion (higher percentages by weight) of fibers can be selected for a better mechanical stability, while, by contrast, with the field of application for a sacrificial layer of a battery cover, a lower proportion of fibers can be selected, since then the mechanical stability is of lesser practical importance. The percentages by weight of fibers can be set in particular by using fibers with different weights per unit of area.

The percentages by weight of oxides can be selected in particular based on the desired percentages by weight of fibers and adjusted accordingly, for example, by the retention time of the fibers in a matrix bath.

The percentages by weight of water can be selected depending on the desired bonding of the input stock, and during production of the input stock, they can be adjusted accordingly, for example, by the retention time of the fibers in a matrix bath and/or by subsequent pressing of a web made of fiber-matrix mixture.

Within the framework of the invention, the input stock can contain approximately 1 to 1.5 wt. % of polyvinyl alcohol, wherein these percentages by weight, such as the percentages by weight of water, can be adjusted.

In an especially preferred embodiment, it is provided that in the case of the inorganic oxides, the proportion of SiO₂ is at least 65 wt. %, in particular at least 70 wt. %, preferably 72 to 77 wt. %, especially preferably approximately 73 to 75 wt. %. In a preferred further development of this embodiment, it is provided that the proportion of Al₂O₃ is in the range of 15 to 20 wt. %.

The special advantage of these embodiments lies in the balance between the temperature stability during the processing and the mechanical properties. The proportion of Al₂O₃ provides for the temperature stability. The balance has an effect in such a way that the input stock can be sintered without the mechanical stability of the fibers and the bonding of the fiber-ceramic composite being impaired.

Within the framework of the invention, it can be provided that the input stock contains additional inorganic oxides selected from the group TiO₂, Fe₂O₃, CaO, MgO, K₂O, and Na₂O. It is advantageous for the various types of stoneware, whose composition can be changed, to be able to be used as initial raw material.

In another, especially preferred embodiment, it is provided that in the case of the inorganic fibers, the proportion of SiO₂ is at least 60 wt. %, and the proportion of Al₂O₃ is at most 25 wt. %, in particular that the proportion of SiO₂ is at least 65 wt. %, in particular at least 70 wt. %, for example 85 wt. %, and the proportion of Al₂O₃ is in the range of 15 to 20 wt. %. When both in fibers and in inorganic oxides, the proportion of SiO₂ is similar in size, there is the advantage that its “finishing” can be omitted. When, moreover, the proportion of SiO₂ predominates over the proportion of Al₂O₃, the advantage exists that the matrix mixture can bind the fibers especially well.

Within the framework of the invention, it can also be provided that in the case of the inorganic fibers, the proportion of SiO₂ is 20 to 30 wt. %, in particular 25 wt. %, and the proportion of Al₂O₃ is 70 to 80 wt. %, in particular 75 wt. %.

Within the framework of the invention, the inorganic fibers—as fabric, sheets, fleece, felt, knitted fabric, mesh—can be arranged in the form of a winding or as a unidirectional fiber layer.

In order to improve the storability of the input stock, the input stock within the framework of the invention can have the form of a flat, rollable web, wherein the top and bottom of the web in each case are formed by a film, and the inorganic fibers, the inorganic oxides, and the water portion are present between the films, or wherein the top or bottom of the web is formed by a film.

According to the invention, the input stock is produced for use for producing a fiber-ceramic composite in a method comprising the following method steps:
a) Production of a suspension comprising water and ground, inorganic oxides and preferably polyvinyl alcohol for later formation of an oxide ceramic matrix,
b) Bringing inorganic fibers into contact in the suspension produced according to step a), and
c) Production of a storage-stable input stock for the fiber-ceramic composite with application of increased pressure.

Within the framework of the invention, it can be provided that the ground, inorganic oxides for forming the oxide ceramic matrix are obtained from stoneware.

In a preferred embodiment, it can be provided that the fibers in step b) in the form of a flat web run through a container, which contains the suspension produced according to step a), and that in step c), the bottom and/or the top of the flat web, which comprises inorganic fibers, inorganic oxides, a water portion, and optionally a polyvinyl alcohol portion, is covered with a film. In particular, the percentages by weight of inorganic oxides, water, and optionally polyvinyl alcohol can be set by the retention time in the container. The water portion in the input stock can be kept essentially constant by the film, and the web can be better positioned.

According to the invention, the input stock is used for producing a fiber-ceramic composite by the following method step being executed:
d) Sintering of the input stock at a temperature of approximately 1000° C., in particular at a temperature of 900 to 990° C., for forming an oxide ceramic matrix.

The matrix according to the invention can be sintered between 90° and 1100° C. In the case of a composite, however, the weakest link determines the sintering temperature, in this case the fibers. The mechanical strength of SiO₂ fibers drops quickly at temperatures above 990° C. The invention, however, is distinguished by a special balance between temperature stability in the production and mechanical properties in the finished composite.

According to the invention, a fiber-ceramic composite comprising inorganic fibers and an oxide ceramic matrix is proposed, which is characterized in that the inorganic fibers consist of SiO₂ and Al₂O₃, and the oxide ceramic matrix consists 100% of inorganic oxides, wherein the proportion of SiO₂ is at least 60 wt. %, and the proportion of Al₂O₃ is at most 25 wt. %.

The composite according to the invention can be produced at relatively low temperatures and thus significantly more economically, wherein mechanical properties and workability can be optimally adapted to various fields of application in which composites consisting predominantly of Al₂O₃ and of only small proportions of SiO₂ were not suitable.

In a preferred embodiment of the composite, it is provided that the proportions of inorganic fibers and the proportions of oxide ceramic matrix are in a range of between 30 and 70 wt. %, preferably between 40 and 60 wt. %, in particular between 35 and 65 wt. %, relative to 100 wt. %.

The individual percentages by weight of fibers and oxides can be selected depending upon requirements. With the field of application for, e.g., the tip of a space rocket, a proportion of fibers of approximately 65 wt. % can be selected for better mechanical stability, while, by contrast, with the field of application for a sacrificial layer of a battery cover, a proportion of fibers of approximately 35 wt. % can be selected, since then the mechanical stability is of practical importance to a lesser extent.

Additional details and features of the invention are given in the description below of a preferred embodiment based on the drawing, in which a unit according to the invention with its essential components is depicted diagrammatically.

For producing the ceramic matrix, stoneware is ground to form a grain size of, for example, 9 μm. The stoneware that is used can consist of, for example, the following oxides:
72% SiO₂, 1% TiO₂, 18% Al₂O₃, 1% Fe₂O₃, 5% CaO, 0.50% MgO, 2% K₂O, 0.50% Na₂O.

The inorganic fibers that are used consist of SiO₂ or Al₂O₃. Preferably, the fibers can contain a mixture that consists of Al₂O₃ and SiO₂, wherein the proportion of Al₂O₃ is, for example, 75%, and the proportion of SiO₂ is 25%. The inorganic fibers can—as fabric, sheets, fleece, felt, knitted fabric, mesh—be arranged in the form of a winding or as a unidirectional fiber layer.

The fibers are continuously unwound by an unwinding unit 1 and guided over guide rollers 2 into a matrix bath. The matrix bath comprises a watering trough 3, in which a mixture that consists of water and polyvinyl alcohol is present and into which the ground stoneware is put. The temperature in the matrix bath can be approximately 20 to 40° C. In the watering trough 3, a circulating pump can be provided in order to prevent sedimentation.

The percentages by weight of the fibers can be adjusted by the weight per unit of area of the fibers that are used, e.g., 300 g/m² or 400 g/m². The percentages by weight of water and polyvinyl alcohol can be affected by the retention time of the fibers in the matrix bath.

The fiber-matrix mixture, which can be referred to as input stock as soon as it exits from the watering trough 3, is guided after the matrix bath by at least one pair 4 of pressure rollers for exerting a contact pressure. By the contact pressure, the suspension is pressed into the inorganic fibers, so that the oxides for forming the ceramic matrix are introduced into the fibers. Moreover, the percentages by weight of water and polyvinyl alcohol can be further affected. The pair of pressure rollers can be slightly cooled, for example to about 15° C. The distance between the pressure rollers can be set depending on the weight per unit of area of the fibers that are used.

After the watering trough 3 and the pair of pressure rollers 4, additional guide rollers 2 are provided, via which the weblike input stock is guided into a storage unit 5, for example a roller for winding up the input stock.

At least one additional guide roller 2 can be a supply roller 6 for a removable film (for example siliconized or waxed), in order to cover the top 7 or the bottom 8 of the input stock with a film, so that the input stock can be better positioned. Also, a pair of rollers can be provided on supply rollers 6 for a removable film in order to cover the top 7 and the bottom 8 of the input stock with a film. In the latter example, a further strengthening of the input stock is carried out by the contact pressure generated there, so that even over a longer period, storage at an appropriate room temperature is possible.

After the pressing, the input stock can contain, for example, 44 wt. % of fibers, 47 wt. % of oxides, 8 wt. % of water, and 0.5 wt. % of polyvinyl alcohol, wherein the percentages by weight of film can be disregarded.

The input stock can be processed immediately after its production or after an appropriate storage period. In this case, for the time being, the film is removed from the surface of the input stock, and the input stock is put in multiple layers into a pressure mold. The pressure mold with the input stock is transferred into a furnace and heated there, depending on further use, for several hours at approximately 30 to 100° C. Then, the pressure mold is removed, and the pressed layers are put into a sintering furnace. The sintering is done at approximately 900 to 1000° C. over a period of 0.25 to 4 hours, thus ensuring that the ceramic matrix and thus the fiber-ceramic composite are produced.

Within the framework of the invention, for example, 300 to 380 g of matrix mixture comprising oxides, water, and optionally polyvinyl alcohol can be applied to 300 to 400 g of fibers. After the sintering, 300 to 400 g of fiber is still present, but the water portion as well as any proportion of polyvinyl alcohol has volatized, so that then, for example, approximately 260 to 320 g of oxides is present.

An analysis of the fiber-ceramic composite produced according to the embodiment can show a matrix with a geometric density of 1.65 g/cm³, a skeleton density of 2.64 g/cm³, and an open porosity of 36%.

The fiber-ceramic composite according to the invention can be used for a series of technical applications. The use for producing battery covers as well as the production of components for aircraft, such as drones, are indicated only by way of example. In addition to the actual applications mentioned in the state of the art, in principle all fields of application are advantageous in which conventional, technical ceramic is used, or in which metal components do not achieve satisfactory service lives because of corrosion or higher temperatures.

In summary, an embodiment of the invention can be described as follows:

An input stock for use for producing a fiber-ceramic composite contains 40 wt. % to 55 wt. % of inorganic fibers consisting of SiO₂ and/or Al₂O₃, 40 wt. % to 50 wt. % of inorganic oxides, and 5 wt. % to 15 wt. % of water, wherein the inorganic oxides contain at least 60 wt. % of SiO₂ and at most 25 wt. % of Al₂O₃. For this purpose, inorganic fibers are brought into contact with a suspension that contains water, ground inorganic oxides, and preferably polyvinyl alcohol. The input stock can be sintered at a later point in time at a temperature of approximately 1000° C., in particular at a temperature of 900 to 990° C. The thus produced fiber-ceramic composite contains inorganic fibers and an oxide ceramic matrix, wherein the inorganic fibers consist of SiO₂ and Al₂O₃, wherein the oxide ceramic matrix consists 100% of inorganic oxides, wherein the proportion of SiO₂ is at least 60 wt. %, and the proportion of Al₂O₃ is at most 25 wt. %.

1. Input stock for use for producing a fiber-ceramic composite, wherein the input stock comprises inorganic fibers, in particular oxide and/or mineral fibers, and inorganic oxides, characterized in that 100 wt. % of input stock contains
40 wt. % to 55 wt. % of inorganic fibers consisting of SiO₂ and/or Al₂O₃,
40 wt. % to 50 wt. % of inorganic oxides, and
5 wt. % to 15 wt. % of water,
and in that 100 wt. % of the inorganic oxides contains at least 60 wt. % of SiO₂ and at most 25 wt. % of Al₂O₃.

2. Input stock according to claim 1, characterized in that it contains 44 wt. % to 50 wt. % of inorganic fibers consisting of SiO₂ and/or Al₂O₃.

3. Input stock according to claim 1, characterized in that it contains 42 wt. % to 48 wt. % of inorganic oxides.

4. Input stock according to claim 1, characterized in that it contains 7.5 wt. % to 9 wt. % of water.

5. Input stock according to claim 1, characterized in that it contains 1 wt. % to 1.5 wt. % of polyvinyl alcohol.

6. Input stock according to claim 1, characterized in that in inorganic oxides, the proportion of SiO₂ is at least 65 wt. %, in particular at least 70 wt. %, preferably 72 to 77 wt. %, especially preferably 73 to 75 wt. %.

7. Input stock according to claim 1, characterized in that in the inorganic oxides, the proportion of Al₂O₃ is in the range of 15-20 wt. %.

8. Input stock according to claim 1, characterized in that it contains additional inorganic oxides selected from the group of TiO₂, Fe₂O₃, CaO, MgO, K₂O, and Na₂O.

9. Input stock according to claim 1, characterized in that in the inorganic fibers, the proportion of SiO₂ is at least 60 wt. %, and the proportion of Al₂O₃ is at most 25 wt. %, in particular in that the proportion of SiO₂ is at least 65 wt. %, in particular at least 70 wt. %, for example, 85 wt. %, and the proportion of Al₂O₃ is in the range of 15 to 20 wt. %.

10. Input stock according to claim 1, characterized in that the inorganic fibers—as fabric, sheets, fleece, felt, knitted fabric, mesh—are arranged in the form of a winding or as a unidirectional fiber layer.

11. Input stock according to claim 1, characterized in that it has the form of a flat, rollable web, wherein the top (7) and the bottom (8) of the web are formed in each case by a film, and the inorganic fibers, the inorganic oxides, and the water portion are present between the films, or wherein the top (7) or the bottom (8) of the web is formed by a film.

12. Method for producing an input stock according to claim 1 for use for producing a fiber-ceramic composite comprising the method steps:
a) Production of a suspension containing water and ground, inorganic oxides and preferably polyvinyl alcohol for later formation of an oxide ceramic matrix,
b) Bringing inorganic fibers into contact in the suspension produced according to step a), and
c) Production of a storage-stable input stock for the fiber-ceramic composite with application of increased pressure.

13. Method according to claim 9, characterized in that the ground, inorganic oxides for forming the oxide ceramic matrix are obtained from stoneware.

14. Method according to claim 9, characterized in that the fibers in step b) in the form of a flat web run through a container (3), which contains the suspension produced according to step a), and in that in step c), the bottom (7) and/or the top (7) of the flat web, which comprises inorganic fibers, inorganic oxides, a water portion, and optionally a polyvinyl alcohol portion, is covered with a film.

15. Use of an input stock according to claim 1 for producing a fiber-ceramic composite comprising the method step:
d) Sintering the input stock at a temperature of approximately 1000° C., in particular at a temperature of 950 to 990° C., for forming an oxide ceramic matrix.

16. Fiber-ceramic composite containing inorganic fibers and an oxide ceramic matrix, characterized in that the inorganic fibers consist of SiO₂ and Al₂O₃, and in that the oxide ceramic matrix consists 100% of inorganic oxides, wherein the proportion of SiO₂ is at least 60 wt. %, and the proportion of Al₂O₃ is at most 25 wt. %.

17. Fiber-ceramic composite according to claim 13, characterized in that the proportions of inorganic fibers and the proportions of the oxide ceramic matrix are in a range of between 30 wt. % and 70 wt. %, preferably between 40 wt. % and 60 wt. %, in particular between 35 wt. % and 65 wt. %, relative to 100 wt. %.
